(19) United States
(12) Patent Application Publication
(10) Pub. No.: US 2024/0410689 A1
(43) Pub. Date: Dec. 12, 2024

(54) METHOD FOR EXTRACTING SURFACE MORPHOLOGY AND FABRIC CHARACTERISTICS OF ROCK ORES AND MINERALS

(71) Applicant: Chengdu University of Technology, Chengdu (CN)

(72) Inventors: Wenli ZHONG, Chengdu (CN); Zhongguo FU, Chengdu (CN); Xuehua CHEN, Chengdu (CN); Cuihua CHEN, Chengdu (CN)

(21) Appl. No.: 18/811,454

(22) Filed: Aug. 21, 2024

(30) Foreign Application Priority Data
Sep. 6, 2023 (CN) 202311141908.X

(51) Int. Cl. G01B 11/30; G01B 9/04; G06T 7/40; G06T 7/529

(52) U.S. Cl. CPC G01B 11/306; G01B 9/04; G06T 7/40; G06T 7/529; G06T 2207/10056; G06T 2207/20024; G06T 2207/20036; G06T 2207/30181

(57) ABSTRACT

A method for extracting surface morphology and fabric characteristics of rock ores and minerals, which includes the following steps. An adaptive two-dimensional (2D) structure enhancement filter operator and its filter aperture in the spatial domain are constructed based on confocal microscopic image data of a rock sample. Attribute data that retains and accentuates structural features of the rock sample is obtained through azimuth scanning. A data-driven higher-order nonlinear spline smoothing function of 2D elevation data is established to determine the optimal 2D localized spline smoothing function. After that, the positive and negative morphology attributes of the surface of the rock sample are calculated, so as to accurately, reliably and quantitatively characterize the surface morphology and fabric characteristics of the rock sample.

### CROSS-REFERENCE TO RELATED APPLICATIONS

This application claims the benefit of priority from Chinese Patent Application No. 202311141908.X, filed on Sep. 6, 2023. The content of the aforementioned application, including any intervening amendments thereto, is incorporated herein by reference in its entirety.

### TECHNICAL FIELD

This application relates to exploration and development of mineral resources, and more particularly to a method for extracting and quantitatively describing surface morphology and fabric characteristics of rock ores and minerals from confocal microscope image data of the rock ores, which can be used to analyze the mineralization process and mechanism of economic minerals in the rock ores, so as to determine their distribution laws and to provide basic support for efficient exploration and development of minerals.

### BACKGROUND

Mineral resources are essential for the high-quality development of China's economy and society, and the consumption of mineral resources in China is considerable, and is still increasingly growing. In order to ensure the sufficient supply of mineral resources, it is crucial to enhance the exploration and technical and economic evaluation of mineral resources, especially the strategic mineral resources, and to discover new mineral reservoirs. In the traditional mineral identification process, the mineral sample is observed under an ordinary optical microscope through naked eyes for identification, structure and morphology observation, and statistical analysis of particle size. However, many metallic minerals and their variants and subspecies have tiny differences in optical and physical properties, and thus are difficult to be distinguished by the naked eyes. The researches about the typomorphism of metal minerals involves the counting of a large number of optical characteristics, and the artificial method has many shortcomings such as large time consumption, low efficiency, large error, etc. Moreover, it is too dependent on the professional knowledge and education of the researchers, which makes it difficult to popularize the mineral identification and analysis.

Confocal microscopy provides an advanced means for observing the surface structure of rock ores and realizing the mineral phase analysis of rock ores. However, the surface structure data of rock ores observed by confocal microscopy cannot intuitively and quantitatively reflect the attribute information of rock ores, such as the surface morphology and spatial configuration characteristics. Hence, the data is required to be further processed to suppress and remove the noise interference, and to isolate the effective features and their distribution information for the subsequent automatic identification of minerals, analysis of the physicochemical conditions of mineralization and the cause of mineralization, and for guiding the exploration of geological prospecting. The method developed by the present disclosure is to extract and quantitatively describe the mineral surface topography and spatial configuration information from the confocal microscopic imaging data of the minerals, so as to support the accurate and efficient automatic identification of minerals and analysis of mineralization process and mechanism.

### SUMMARY

An objective of the present disclosure is to provide a method for extracting and quantitatively describing surface morphology and spatial configuration characteristics of rock ores and minerals from confocal microscope image data of rock ores. The principle of the method is to retain and highlight the effective information in the confocal microscopic image data of the rock and ore, and establish a method to enhance the processing and extraction of the spatial discontinuity information of the rock and ore, so as to quantitatively characterize the spatial configuration and distribution of minerals, and support the high-precision and high-efficiency identification of minerals and the analysis of mineralization laws.

Technical solutions of the present disclosure are described below.

A method for extracting surface morphology and spatial configuration characteristics of rock ores and minerals, comprising:
(S1) preparing a rock sample from a rock core or an outcrop, wherein the rock core is taken by drilling;
(S2) scanning, by a confocal laser scanning microscope, the rock sample to obtain two-dimensional (2D) digital image of the rock sample;
(S3) extracting structural feature vectors of the rock sample, by a feature generator including a filter that extracts mineral structural textures, from the 2D digital image;
(S4) deriving 2D elevation feature values of the rock sample according to the structural feature vectors of the rock sample; and
(S5) transforming the 2D elevation feature values into a positive topographic image and a negative topographic image.

In an embodiment, in step (S2), image data of the 2D digital image of the rock sample is represented by M(x,y), wherein x and y represent an x-axis coordinate and a y-axis coordinate of the image data, respectively; a data acquisition interval in an x-axis direction is represented by dx, in unit of meters (m); a data acquisition interval in a y-axis direction is represented by dy, in unit of m; and the number of data points in the x-axis direction is I, and the number of sampling points in the y-axis direction is J.

In an embodiment, step (S3) comprises:
performing 2D Fourier transform on the image data M(x,y) to obtain 2D wavenumber spectrum data M_{f}(Kₓ,K_{y}), wherein Kₓ represents a spatial wavenumber of the image data in the x-axis direction, and K_{y} represents a spatial wavenumber of the image data in the y-axis direction;
extracting a wavenumber scale factor (dKₓ,dK_{y}) according to the following formula:

$$( {dK}_{x} , {dK}_{y} ) ∼ {M}_{f} ( {dK}_{x} , {dK}_{y} ) = max [ {M}_{f} ( {K}_{x} , {K}_{y} ) ] ;$$

wherein max(·) represents an operator for obtaining a maximum value; and
establishing a 2D structure enhancement filter F(x,y;aₓ,a_{y}) for the image data M(x,y), wherein (aₓ,a_{y}) represents a filter aperture length in the x-axis direction and the y-axis direction, and constitutes a function of the wavenumber scale factor (dKₓ,dK_{y}); and performing an azimuth scanning on the image data M(x,y) based on the 2D structure enhancement filter F(x,y;aₓ,a_{y}) to obtain attribute data S(x,y) that retains and accentuates structural features of the rock sample, expressed by:

$$S ( x , y ) = \frac{{\sum }_{m = 1}^{{a}_{x}} {\sum }_{n = 1}^{{a}_{y}} [ M ( x + m \cdot dx , y + n \cdot dy ) F ( x + m \cdot dx , y + n ; {a}_{x} , {a}_{y} ) ]}{{\sum }_{m = 1}^{{a}_{x}} {\sum }_{n = 1}^{{a}_{y}} F ( x + m \cdot dx , y + n ; {a}_{x} , {a}_{y} )} ;$$

wherein m represents a serial number of the sampling points in the x-axis direction within the filter aperture, and n represents a serial number of the sampling points in the y-axis direction within the filter aperture.

In an embodiment, step (S4) comprises:
(i) establishing a higher-order nonlinear spline smoothing function C(x,y;aₓ,a_{y}) of three-dimensional (3D) elevation data with an aperture of (aₓ,a_{y}) by taking each data point S(xᵢ,yⱼ) of the attribute data S(x,y) as a target center control point; obtaining an optimal feature control vector set C(x,y;aₓ,a_{y}) through an iterative search algorithm to acquire an optimal 3D local spline smoothing function Cₒ(xᵢ,yⱼ); wherein i∈[0,I−1] and j∈[0,J−1], and i represents an index number of a data point in the x-axis direction, and j represents a serial number of a data point in the y-axis direction;
(ii) calculating feature vectors z(i,j), λ(i,j), γ(i,j) and ç(i,j) based on Cₒ(x,y):

$$\{ \begin{matrix}z ( i , j ) = max [ {C}_{o} ( {x}_{i} , {y}_{j} ) ] \\ λ ( i , j ) = α \frac{{\partial }^{2}}{\partial {x}^{2}} {C}_{o} ( {x}_{j} , {y}_{j} ) \\ γ ( i , j ) = α \frac{{\partial }^{2}}{\partial {y}^{2}} {C}_{o} ( {x}_{j} , {y}_{j} ) \\ ς ( i , j ) = β \frac{{\partial }^{2}}{\partial x \partial y} {F}_{O} ( τ , x , y )\end{matrix}$$

wherein α and β are reference morphology adjustment factors; and
(iii) calculating an attribute data Tₚ(i,j) of the positive topographic image and an attribute data Tₙ(i,j) of the negative topographic image of the rock sample at the target center control point based on the feature vectors respectively through the following formulas:

$$\{ \begin{matrix}{T}_{p} ( i , j ) = 1 + \frac{1}{{z}^{2} ( i , j )} \sqrt{{[ λ ( i , j ) - γ ( i , j ) ]}^{2} + {ς}^{2} ( i , j )} \\ {T}_{n} ( i , j ) = 1 - \frac{1}{{z}^{2} ( i , j )} \sqrt{{[ λ ( i , j ) - γ ( i , j ) ]}^{2} + {ς}^{2} ( i , j )}\end{matrix} ;$$

and
(iv) repeating steps (i)-(iii) until corresponding calculations for all data points of the attribute data S(x,y) are completed to obtain all attribute data Tₚ(x,y) of the positive topographic image and all attribute data Tₙ(x,y) of the negative topographic image of a surface of the rock sample for quantitative description and analysis of mineral surface topographic and fabric information.

### BRIEF DESCRIPTION OF THE DRAWINGS

FIG. 1 is a raw data image of a first calcite sample observed by confocal microscopy according to an embodiment of the present disclosure, where the first calcite sample is collected from an exploration area 1;

FIG. 2a is a positive topographic image of the first calcite sample showing property results of a surface of the first calcite sample calculated by a method provided by the present application according to an embodiment of the present disclosure;

FIG. 2b is a negative topographic image of the first calcite sample showing property results of the surface of the first calcite sample calculated by the method provided by the present application according to an embodiment of the present disclosure;

FIG. 3 is a raw data image of a second calcite sample observed by confocal microscopy according to an embodiment of the present disclosure, where the second calcite sample is collected from an exploration area 2;

FIG. 4a is a positive topographic image of the second calcite sample showing property results of a surface of the second calcite sample calculated by a method provided by the present application according to an embodiment of the present disclosure; and

FIG. 4b is a negative topographic image of the second calcite sample showing property results of the surface of the second calcite sample calculated by the method provided by the present application according to an embodiment of the present disclosure;

### DETAILED DESCRIPTION OF EMBODIMENTS

A method for extracting surface morphology and spatial configuration characteristics of rock ores and minerals is provided, which includes the following steps.

(S1) A rock sample is prepared from a rock core taken by drilling, or an outcrop.

(S2) The rock sample is scanned by a confocal laser scanning microscope to obtain a two-dimensional (2D) digital image of the rock sample.

(S3) Structural feature vectors of the rock sample are extracted from the 2D digital image by a feature generator including a filter that extracts mineral structural textures.

(S4) 2D elevation feature values of the rock sample are derived according to the structural feature vectors of the rock sample, and the 2D elevation feature values are transformed into positive topographic images and negative topographic images.

By using a computer instead of a conventional camera, the confocal laser scanning microscope is capable of capturing digitized images that can be output instantly and stored for long periods of time. It allows the user to perform continuous scans over time on the same sample plane, thereby analyzing structure of the sample, inclusions, and kinetic changes in markers. The confocal laser scanning microscope is commercially available, and its structure is not specifically introduced herein. Compared to the traditional cameras, the confocal laser scanning microscope can capture digital images, and the captured images can be instantly output and stored for a long time. The confocal laser scanning microscope allows users to perform continuous scanning on the same sample plane over time, enabling the analysis of sample structure, inclusions, and dynamics of markers. The feature generator includes filters such as mean, variance, Sobel, Gabor, Histogram of Oriented Gradients (HOG), Laplacian. and Hessian filters. These filters are typically digital filters.

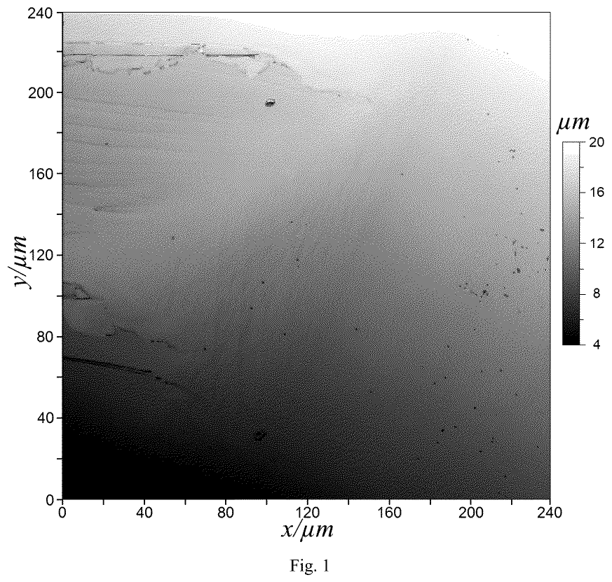

In an embodiment, image data M(x,y) (as shown in FIG. 1) of a first calcite sample collected from an exploration area 1 is obtained via the confocal laser scanning microscope, where spatial sampling intervals of the image data in an x-axis direction and a y-axis direction are both 1 μm.

In an embodiment, step (S3) includes the following steps.

Two-dimensional (2D) Fourier transform is performed on the image data M(x,y) of FIG. 1 to obtain 2D wavenumber spectrum data M_{f}(Kₓ, K_{y}), and a wavenumber scale factor (dKₓ, dK_{y}) is extracted according to the following formula:

$$( {dK}_{x} , {dK}_{y} ) ∼ {M}_{f} ( {dK}_{x} , {dK}_{y} ) = max [ {M}_{f} ( {K}_{x} , {K}_{y} ) ] .$$

A 2D structure enhancement filter F(x,y;aₓ,a_{y}) for the image data M(x,y) is established, where (aₓ,a_{y}) represents a filter aperture length in the x-axis direction and the y-axis direction, and constitutes a function of the wavenumber scale factor (dKₓ,dK_{y}). An azimuth scanning is performed on the image data M(x,y) based on the 2D structure enhancement filter F(x,y;aₓ,a_{y}) to obtain attribute data S(x,y) that retains and accentuates structural features of the rock sample, expressed by:

$$S ( x , y ) = \frac{{\sum }_{m = 1}^{{a}_{x}} {\sum }_{n = 1}^{{a}_{y}} [ M ( x + m \cdot dx , y + n \cdot dy ) F ( x + m \cdot dx , y + n ; {a}_{x} , {a}_{y} ) ]}{{\sum }_{m = 1}^{{a}_{x}} {\sum }_{n = 1}^{{a}_{y}} F ( x + m \cdot dx , y + n ; {a}_{x} , {a}_{y} )} ;$$

where m represents a serial number of the sampling points in the x-axis direction within the filter aperture, and n represents a serial number of the sampling points in the y-axis direction within the filter aperture.

In an embodiment, step (S4) further includes the following steps.

(i) A higher-order nonlinear spline smoothing function C(x,y;aₓ,a_{y}) of three-dimensional (3D) elevation data with an aperture of (aₓ,a_{y}) is established by taking each data point S(xᵢ,yⱼ) of the attribute data S(x,y) as a target center control point. An optimized feature control vector set C(x,y;aₓ,a_{y}) is obtained through an iterative search algorithm to acquire an optimized 3D local spline smoothing function Cₒ(xᵢ,yⱼ), where i∈[0,I−1] and j∈[0,J−1], and i represents an index number of a data point in the x-axis direction, and j represents a serial number of a data point in the y-axis direction.

(ii) The following feature vectors z(i,j), λ(i,j), γ(i,j) and ç(i,j) are calculated based on Cₒ (xᵢ,yⱼ):

$$\{ \begin{matrix}z ( i , j ) = max [ {C}_{o} ( {x}_{i} , {y}_{j} ) ] \\ λ ( i , j ) = α \frac{{\partial }^{2}}{\partial {x}^{2}} {C}_{o} ( {x}_{j} , {y}_{j} ) \\ γ ( i , j ) = α \frac{{\partial }^{2}}{\partial {y}^{2}} {C}_{o} ( {x}_{j} , {y}_{j} ) \\ ς ( i , j ) = β \frac{{\partial }^{2}}{\partial x \partial y} {F}_{O} ( τ , x , y )\end{matrix} .$$

(iii) An attribute data Tₚ(i,j) of a surface positive topographic image and an attribute data Tₙ(i,j) of a surface negative topographic image of the first calcite sample at the target center control point are calculated based on the feature vectors respectively through the following formulas:

$$\{ \begin{matrix}{T}_{p} ( i , j ) = 1 + \frac{1}{{z}^{2} ( i , j )} \sqrt{{[ λ ( i , j ) - γ ( i , j ) ]}^{2} + {ς}^{2} ( i , j )} \\ {T}_{n} ( i , j ) = 1 - \frac{1}{{z}^{2} ( i , j )} \sqrt{{[ λ ( i , j ) - γ ( i , j ) ]}^{2} + {ς}^{2} ( i , j )}\end{matrix} .$$

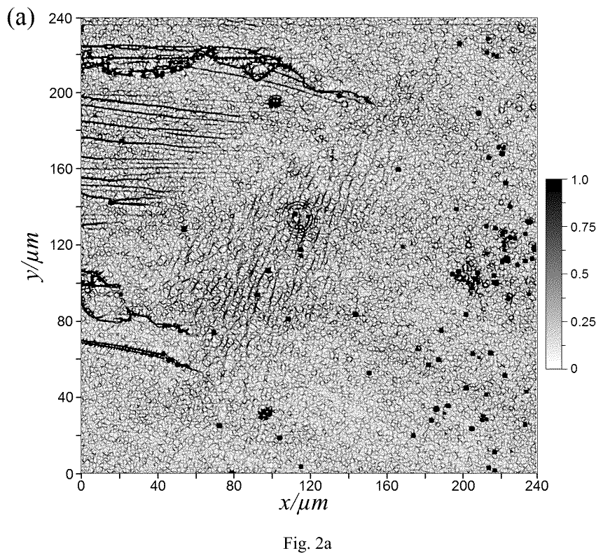

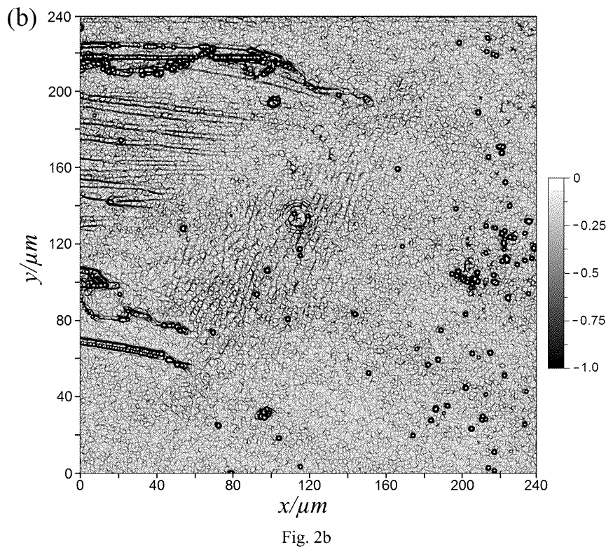

(iv) Steps (i)-(iii) are repeated until corresponding calculations for all data points of the attribute data S(x,y) are completed to obtain the all attributes data Tₚ(x,y) of the positive topographic image (as shown in FIG. 2a) and all attributes data Tₙ(x,y) of the negative topographic image (as shown in FIG. 2b) of a surface of the rock sample. As can be seen in FIGS. 2a-2b, it clearly demonstrates the spatial distribution of mineral cleavage or edge in different directions, which has regional and periodic alternating changes. In addition, the infiltration status of other mineral particles are also clearly visible. Compared with FIG. 1, the topographic images shown in FIGS. 2a-2b are significantly enhanced, particularly highlighting the creaks (i.e., mineral cleavage) with different directions and the circles due to the infection of mineral particles, which are inapparently shown in FIG. 1.

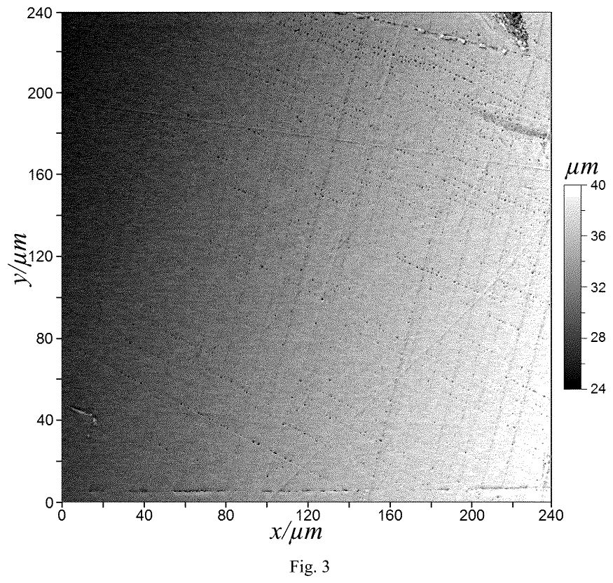

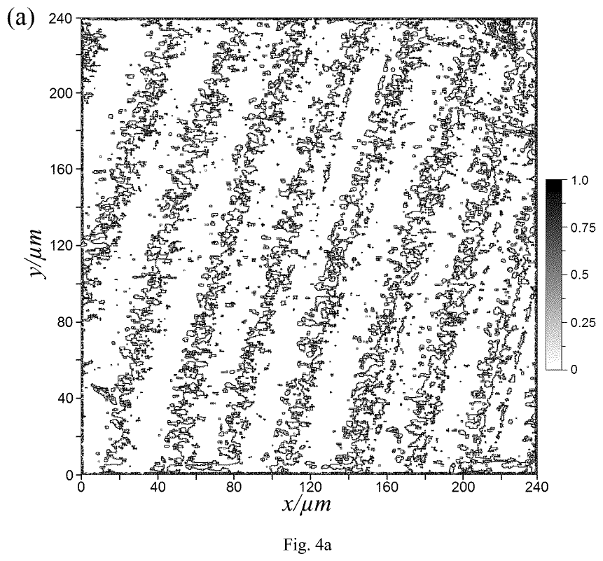

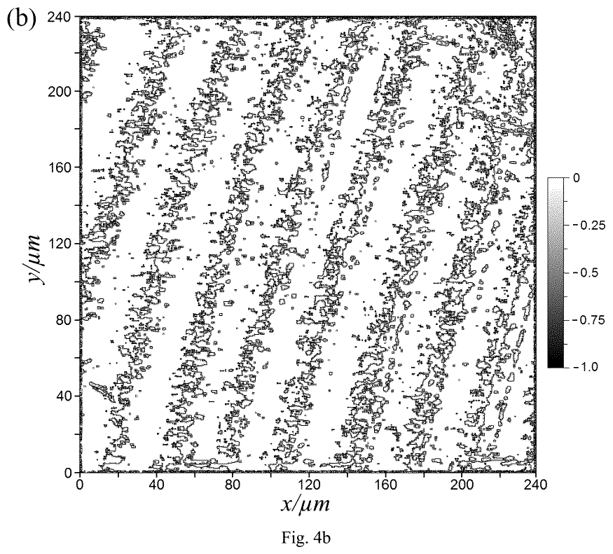

FIG. 3 is a raw data image of a second calcite sample that is collected from an exploration area 2 observed by confocal microscopy. The property results of the positive morphological image (as shown in FIG. 4a) and the property results of the negative morphological image (as shown in FIG. 4b) of the surface are calculated in accordance with the above-mentioned specific implementations. FIGS. 4a and 4b show a periodical distribution in strips, presenting a variability of structural features, and reflecting the existence of periodic changes in the differential growth on surfaces of calcite minerals during the mineralizing process. Compared with FIG. 3, the morphological images shown in FIGS. 4a-4b are significantly enhanced, particularly highlighting periodical distribution in strips, which is non-obvious in FIG. 3.

In summary, the clear and accurate mineral surface morphology and spatial configuration information reflected in FIGS. 2a-2b and 4a-4b are difficult to be reliably identified and determined in the confocal microscope image data of FIGS. 1 and 3, reflecting the superiority of the method of the present disclosure. The surface morphology attributes of the rock and ore in FIGS. 2a-2b and 4a-4b can provide important support for the physical phase analysis of calcite minerals in different work zones, the physicochemical conditions of mineralization, and the analysis of mineral genesis. The method of the present disclosure can be used to guide the identification of economic minerals and the exploration and development of mineral resources.

The advantages of the present disclosure are as follows.

(1) The present disclosure constructs an adaptive two-dimensional (2D) structure enhancement filter and its filtering aperture in the spatial domain, and an azimuthal scanning processing algorithm based on the characteristics of actual confocal microscope image data, which can obtain attribute data that retains and accentuates structural features of minerals.

(2) The present disclosure establishes a higher-order nonlinear spline smoothing function for 2D elevation data driven by actual confocal microscope image data, and an optimized 2D local spline smoothing function and its optimization determination algorithm.

(3) The present disclosure defines the positive and negative morphological properties of the surface of the rock ore and their analytical calculation methods, which can accurately and reliably quantitatively describe the spatial configuration of minerals and their distribution characteristics, provide basic support for high-precision and high-efficiency identification of minerals, characterization determination, analysis of physicochemical conditions of mineralization and mineral genesis laws, and improve the level of research in the fields of mineral resources exploration, geologic diagenesis and metallogenesis processes, and environmental sciences, etc.

The above embodiments are only used to illustrate the present disclosure. The various steps of the method provided herein can be changed. Any equivalent alternations and improvements on the basis of the technical solutions of the present disclosure shall not be excluded from the scope of protection of the present disclosure.

What is claimed is:

1. A method for extracting surface morphology and fabric characteristics of rock ores and minerals, comprising:
(S1) preparing a rock sample from a rock core or an outcrop, wherein the rock core is taken by drilling;
(S2) scanning, by a confocal laser scanning microscope, the rock sample to obtain a two-dimensional (2D) digital image of the rock sample;
(S3) extracting, by a feature generator including a filter that extracts mineral structural textures, structural feature vectors of the rock sample from the 2D digital image; and
(S4) deriving 2D elevation feature values of the rock sample according to the structural feature vectors of the rock sample; and transforming the 2D elevation feature values into a positive topographic image and a negative topographic image of a surface of the rock sample for quantitative description and analysis of mineral surface topographic and fabric information.

2. The method of claim 1, wherein in step (S2), image data of the 2D digital image of the rock sample is represented by M(x,y) wherein x and y represent an x-axis coordinate and a y-axis coordinate of the image data, respectively; a data acquisition interval in an x-axis direction is represented by dx, in unit of meters (m); a data acquisition interval in a y-axis direction is represented by dy, in unit of m; and the number of data points in the x-axis direction is I, and the number of sampling points in the y-axis direction is J;

3. The method of claim 2, wherein step (S3) comprises:
performing 2D Fourier transform on the image data M(x,y) to obtain 2D wavenumber spectrum data M_{f}(Kₓ, Kⱼ), wherein Kₓ represents a spatial wavenumber of the image data in the x-axis direction, and K_{y} represents a spatial wavenumber of the image data in the y-axis direction;
extracting a wavenumber scale factor (dKₓ,dK_{y}) according to the following formula:
$$( {dK}_{x} , {dK}_{y} ) ∼ {M}_{f} ( {dK}_{x} , {dK}_{y} ) = max [ {M}_{f} ( {K}_{x} , {K}_{y} ) ] ;$$
wherein max(⋅) represents an operator for obtaining a maximum value; and
establishing a 2D structure enhancement filter F(x,y; aₓ, a_{y}) for the image data M(x,y), wherein (aₓ,a_{y}) represents a filter aperture length in the x-axis direction and the y-axis direction, and constitutes a function of the wavenumber scale factor (dKₓ,dK_{y}); and performing an azimuth scanning on the image data M(x,y) based on the 2D structure enhancement filter F(x,y;aₓ,a_{y}) to obtain attribute data S(x,y) that retains and accentuates structural features of the rock sample, expressed by:
$$S ( x , y ) = \frac{{\sum }_{m = 1}^{{a}_{x}} {\sum }_{n = 1}^{{a}_{y}} [ M ( x + m \cdot dx , y + n \cdot dy ) F ( x + m \cdot dx , y + n ; {a}_{x} , {a}_{y} ) ]}{{\sum }_{m = 1}^{{a}_{x}} {\sum }_{n = 1}^{{a}_{y}} F ( x + m \cdot dx , y + n ; {a}_{x} , {a}_{y} )} ;$$
wherein m represents a serial number of the sampling points in the x-axis direction within the filter aperture, and n represents a serial number of the sampling points in the y-axis direction within the filter aperture;

4. The method of claim 3, wherein step (S4) comprises:
(i) establishing a higher-order nonlinear spline smoothing function C(x,y;aₓ,a_{y}) of three-dimensional (3D) elevation data with an aperture of (aₓ,a_{y}) by taking each data point S(xᵢ,yⱼ) of the attribute data S(x,y) as a target center control point; obtaining an optimal feature control vector set C(x,y;aₓ,a_{y}) through an iterative search algorithm to acquire an optimal 3D local spline smoothing function Cₒ(xᵢ,yⱼ); wherein i∈[0,I−1] and j∈[0,J−1], and i represents an index number of a data point in the x-axis direction, and j represents a serial number of a data point in the y-axis direction;
(ii) calculating feature vectors z(i,j), λ(i,j), γ(i,j) and ç(i,j) based on Cₒ(xᵢ,yⱼ):
$$\{ \begin{matrix}z ( i , j ) = max [ {C}_{o} ( {x}_{i} , {y}_{j} ) ] \\ λ ( i , j ) = α \frac{{\partial }^{2}}{\partial {x}^{2}} {C}_{o} ( {x}_{j} , {y}_{j} ) \\ γ ( i , j ) = α \frac{{\partial }^{2}}{\partial {y}^{2}} {C}_{o} ( {x}_{j} , {y}_{j} ) \\ ς ( i , j ) = β \frac{{\partial }^{2}}{\partial x \partial y} {F}_{O} ( τ , x , y )\end{matrix} ;$$
wherein α and β are reference morphology adjustment factors; and
(iii) calculating an attribute data Tₚ (i,j) of a positive topographic image and an attribute data Tₙ(i,j) of a negative topographic image of the rock sample at the target center control point based on the feature vectors respectively through the following formulas:
$$\{ \begin{matrix}{T}_{p} ( i , j ) = 1 + \frac{1}{{z}^{2} ( i , j )} \sqrt{{[ λ ( i , j ) - γ ( i , j ) ]}^{2} + {ς}^{2} ( i , j )} \\ {T}_{n} ( i , j ) = 1 - \frac{1}{{z}^{2} ( i , j )} \sqrt{{[ λ ( i , j ) - γ ( i , j ) ]}^{2} + {ς}^{2} ( i , j )}\end{matrix} ;$$
and
(iv) repeating steps (i)-(iii) until corresponding calculations for all data points of the attribute data S(x,y) are completed to obtain all attribute data Tₚ(x,y) of the positive topographic image and all attribute data Tₙ(x,y) of the negative topographic image of a surface of the rock sample for quantitative description and analysis of mineral surface topographic and fabric information.
